(19) United States
(12) Patent Application Publication
(10) Pub. No.: US 2023/0090362 A1
(43) Pub. Date: Mar. 23, 2023

(54) REUSABLE AND WASHABLE BULLETIN BOARD

(71) Applicants: David Corrales, San Diego, CA (US); Gina Harrison, Ramona, CA (US); Anthony Manzon, Bonita, CA (US); Regina Manzon, Bonita, CA (US)

(72) Inventors: David Corrales, San Diego, CA (US); Gina Harrison, Ramona, CA (US); Anthony Manzon, Bonita, CA (US); Regina Manzon, Bonita, CA (US)

(21) Appl. No.: 17/481,822

(22) Filed: Sep. 22, 2021

(51) Int. Cl. G09F 15/00

(52) U.S. Cl. CPC G09F 15/0012; G09F 15/0018

(57) ABSTRACT

A reusable and washable bulletin board may include a rear frame at least partially disposed around a reusable, washable adhesive layer disposed on a backing substrate constructed and arranged to secure items thereto. The reusable, washable adhesive layer does not require the use of a fastening mechanism to attach items such as paper, photos, notes, or the like thereto. The rear frame or backing substrate removably and replaceable and may be magnetic such that items may be magnetically attached to the rear frame or the layer. The reusable and washable bulletin board may further include a removable and replaceable cover substrate and front frame constructed and arranged to be fastened to the rear frame to cover at least a portion of the rear frame and the layer.

### TECHNICAL FIELD

The embodiments generally relate to bulletin or notice boards.

### BACKGROUND

Bulletin boards, idea boards, storyboards, cork boards, foamboards, and the like may utilize attachment mechanisms such that users may firmly attach various items to the bulletin board. For example, tape, pins, tacks, or the like may be used to fix paper, photos, or the like to bulletin boards.

Means for attaching items to bulletin boards such as fastening mechanisms may be easily misplaced or lost or may be potentially dangerous by using sharp pins or tacks.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments described herein provide a bulletin board capable of securely attaching material thereon without the need for additional attachment mechanisms or fasteners.

A reusable and washable bulletin board may include a rear frame at least partially disposed around a reusable, washable adhesive layer disposed on a backing substrate constructed and arranged to secure items thereto. In some instances, the reusable, washable adhesive layer may include a removable, replaceable backing substrate and rear frame to provide a rigid surface behind the layer. According to some embodiments, the frame may include a multi-piece construction configured to seat at least a portion of the backing substrate or reusable, washable adhesive layer therein. In some instances, the rear frame or backing substrate may be magnetic such that items may be magnetically attached to the rear frame or the layer. The reusable and washable bulletin board may further include a cover substrate constructed and arranged to be fastened to the rear frame to cover at least a portion of the rear frame and the layer. In some instances, the cover substrate is magnetic. In some instances, a front frame may be disposed around the cover substrate and may be constructed and arranged to mechanically or magnetically attach to the rear frame thereby covering the rear frame and layer.

The reusable, washable bulletin board may be various shapes and sizes and the examples given herein, with respect to shape and size, shall not be considered limiting.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the reusable and washable bulletin board, according to some embodiments; and

FIG. 2 illustrates a partial view of the rear frame and layer of a reusable and washable bulletin board, according to some embodiments;

FIG. 3 illustrates a perspective view of the rear frame and layer of a reusable and washable bulletin board, according to some embodiments;

FIG. 4 illustrates a rear view of the front frame and cover substrate of a reusable and washable bulletin board, according to some embodiments;

FIG. 5 illustrates a side view of a reusable and washable bulletin board, according to some embodiments;

FIG. 6 illustrates a cross-sectional side view of a reusable and washable bulletin board, according to some embodiments;

FIG. 7 illustrates an exploded view of a reusable washable bulletin board including an assemblable, multi-piece frame; and

FIG. 8 illustrates a cross-sectional view of a reusable washable bulletin board including an assemblable, multi-piece frame.

### DETAILED DESCRIPTION

The specific details of the single embodiment or variety of embodiments described herein are to the described apparatus. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the apparatus. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

In general, the embodiments provided herein relate to a multi-piece, coverable, washable, and reusable bulletin board. A washable and reusable adhesive layer may be disposed on a backing substrate, both of which may be framed by a rear frame. According to some variations, the washable and reusable adhesive layer may be integrated with the backing substrate such that items may be attached to the bulletin board without the use of fascinating mechanisms. The rear frame may include means for attaching the assembly of the adhesive layer, backing substrate, and rear frame to a wall or surface. The rear frame may include a means for attaching to a front frame which may be disposed around a cover substrate. The front frame and cover substrate assembly may be mated with the rear frame such that the rear frame is covered by the front frame, and the adhesive layer is covered by the cover substrate. According to some embodiments, the cover substrate may be transparent. In other instances, the front frame, the rear frame, the cover substrate, or the backing substrate may be magnetic. The cover substrate maybe removably attached to the front frame, and the front frame maybe attachable so the rear frame without the addition of the cover substrate such that the adhesive layer is accessible for use. The cover substrate may be reattached as desired to protect items attached to the adhesive layer when the reusable board is not in use.

The front frame and rear frame may be made of any suitable rigid or semi rigid materials such as, but not limited to, plastic wood, metal, or other materials. The backing substrate may be made of any suitable rigid or semi rigid materials such as, but not limited to, plastic, wood, metal, cardboard, or the like. Similarly, the cover substrate may be made of any suitable rigid, semi rigid, or elastic material, such as, but not limited to, plastic, wood, metal, cardboard, textile, or the like.

In general, the embodiments provided herein relate to a multi-piece, coverable, washable, and reusable bulletin board. A washable and reusable adhesive layer may be disposed on a backing substrate, both of which may be framed by an assemblable multi-piece frame. The assemblable multi-piece frame may include several assemblable frame portions which may be attached to one another to form the multi-piece frame. As a non-limiting example, a generally rectangular multi-piece frame may include four assemblable frame portions that may be affixed to one another such that a backing substrate having a reusable, washable layer thereon may be seated within the multi-piece frame. The multi-piece frame may also be constructed and arranged to secure a cover substrate at least partially over the backing substrate having a reusable, washable layer thereon. As a non-limiting example, a generally circular multi-piece frame may include two or more arc shaped frame portions that may be affixed to one another such that a backing substrate having a reusable, washable layer thereon may be seated within the multi-piece frame. Various other frame shapes and sizes are contemplated by the body of this disclosure including, but not limited to, triangular, hexagonal, octagonal, or the like.

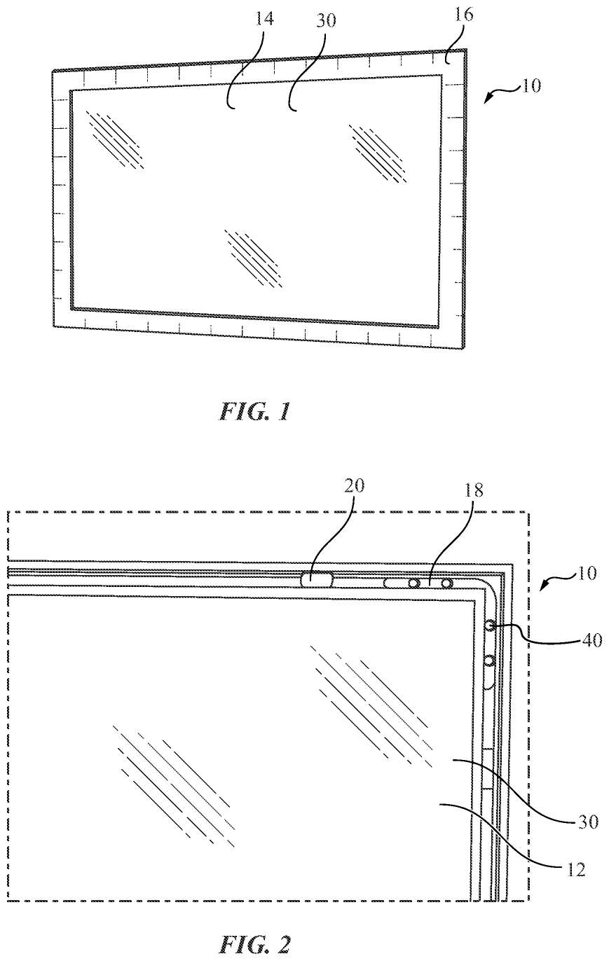

FIG. 1 illustrates a reusable and washable bulletin board 10 including a front frame 16, a cover substrate 14 disposed within the front frame 16, and a washable, reusable adhesive layer 30 disposed behind the cover substrate 14.

FIG. 2 illustrates a portion of a reusable and washable bulletin board 10 including a rear frame 18 disposed around a backing substrate 12 having and washable, reusable adhesive layer 30 disposed thereon. The rear frame 18 may include attachment means 20 constructed and arranged to engage with a portion of the front frame 16 such that the rear frame 18 and front frame 16 may be even mechanically connected to one another. The front frame and rear frame may be affixed to one another by various means including those which have not been expressly stated in this disclosure. The rear frame may further include through holes 40 which may be constructed and arranged to facilitate the attachment of the rear frame to a wall or surface by way of, as a non-limiting example, screws, nails, or nut and bolt combinations.

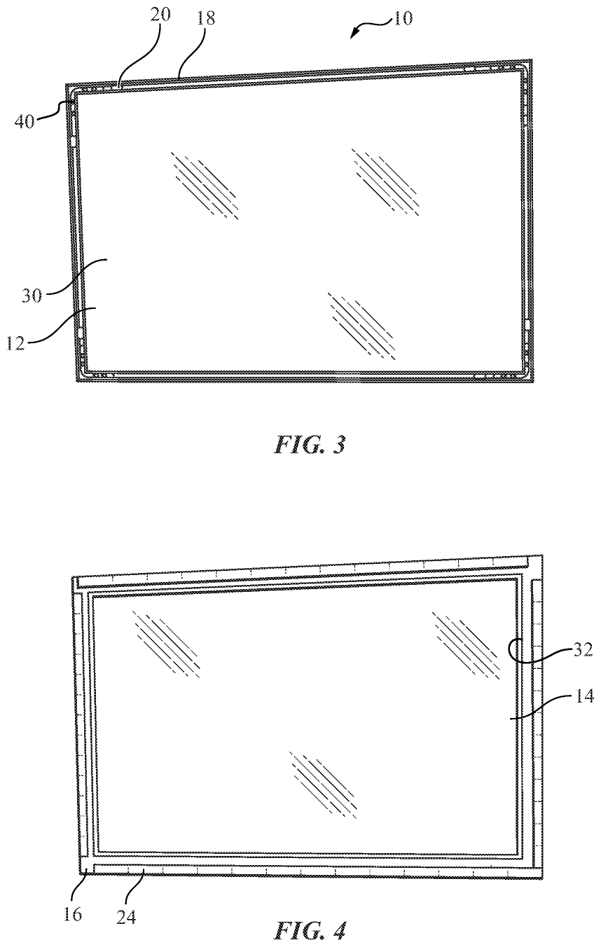

FIG. 3 illustrates a reusable and washable bulletin board 10 including a rear frame 18 disposed around a backing substrate 12 having and washable, reusable adhesive layer 30 disposed thereon. The rear frame 18 may include attachment means 20 constructed and arranged to engage with a portion are the front frame 16 such that the rear frame 18 and front frame 16 may be mechanically connected to one another. As previously described, the front frame and rear frame may be affixed to one another by various means including those which have not been expressly stated in this disclosure. The rear frame may further include through holes 40 which may be constructed and arranged to facilitate the attachment of the rear frame to a wall or surface by way of, as a non-limiting example, screws or nut and bolt combinations. While a generally rectangular rear frame, backing substrate, and adhesive layer are shown, one of ordinary skill in the art will understand and appreciate that the shape and size of the components that make up the reusable and washable bulletin board may vary and still fall within the scope of the invention.

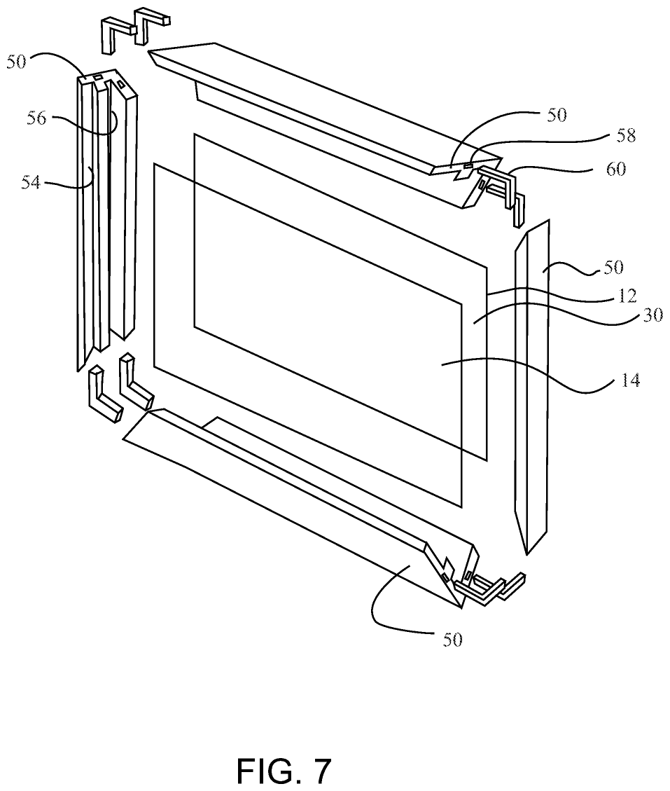

FIG. 4 illustrates a rear view of a reusable and washable bulletin board including a front frame 16, a cover substrate 14 disposed within the front frame 16, and at least one padding strip 24 disposed behind a portion of the front frame to cushion the connection of the front frame 16 to the rear frame. The front frame 16 may also define a perimeter recess 32, as best seen in FIG. 6, constructed and arranged to receive a perimeter portion of the covered substrate 14 therein.

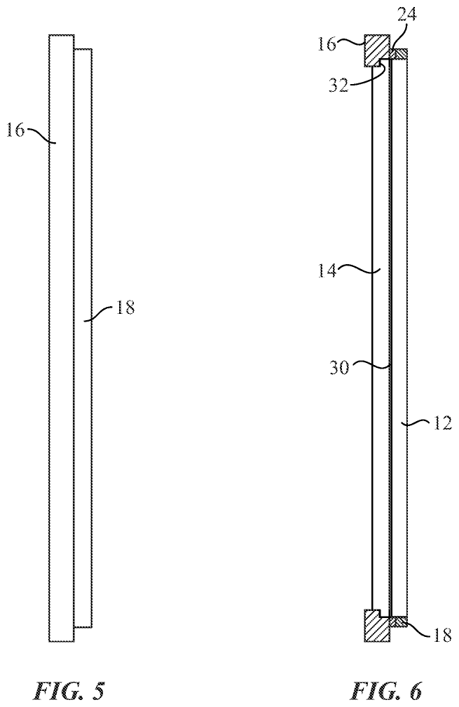

FIG. 5 illustrates a side view of a reusable and washable bulletin board including a rear frame 18 affixed to a front frame 16. According to some variations, the front frame 16 may be constructed and arranged to fully cover the rear frame 18 when the reusable and washable bulletin board is viewed from the front such that the rear frame 18 is unnoticed.

FIG. 6 illustrates a cross sectional side view of a reusable washable bulletin board including a rear frame 18 disposed around a backing substrate 12 having a reusable, washable adhesive layer 30 disposed thereon. The first frame 16 may be disposed around the cover substrate 14, which may be sandwiched over the rear frame 18, backing substrate 12, and washable adhesive layer 30. At least one padding strip 24 may be disposed between the front frame 16 and the rear frame 18, and in some variations, the padding strip 24 may be adhesive to facilitate the attachment of the front frame 16 to the rear frame 18. The front frame 16 may define a perimeter recess 32 constructed and arranged to retain a portion of at least one of the cover substrate 14, layer 30, backing substrate 12, or rear frame 18 therein. According to some embodiments, the front frame 16 may define a perimeter recess 32 constructed and arranged to retain each of the cover substrate 14, layer 30, backing substrate 12, and rear frame 18. According to some embodiments, the perimeter recess 32 may include a plurality of magnets integrated therein, and the cover substrate 14 may include a second plurality of magnets integrated therein such that when the cover substrate 14 is disposed within the perimeter recessed 32, the two may be magnetically attached to and removable from one another.

FIG. 7 illustrates an exploded view of a reusable washable bulletin board including a multi-piece frame 50 constructed and arranged to enclose a removable, replaceable backing substrate 12 having a reusable, washable adhesive layer 30 disposed thereon. A cover substrate 14 may be disposed over the backing substrate 12 and washable adhesive layer 30. The multi-piece frame 50 may include a plurality of assemblable frame portions each defining a backing substrate slot 56 and a cover substrate recess 54. According to one variation, each of the assemblable frame portions may have an approximately “F” shaped cross section. However, other variations on the cross section of each of the assemblable frame portions are contemplated by this disclosure. Each of the assemblable frame portions may define at least one keyhole 58 constructed and arranged to receive at least one key 60 therein such that each of the assemblable frame portions may be affixed to one another at the corners of the multi-piece frame 50. According to some variations, the at least one key 60 may be approximately “L” shaped. In this way, the multi-piece frame 50 may securely seat the backing substrate 12 having a washable, reusable adhesive layer 30 thereon within the backing substrate slot 56 of each of the assemblable frame portions. The cover substrate 14 may be disposed within the cover substrate recess defined by each of the assemblable frame portions of the multi-piece frame 50. According to one variation, the multi-piece frame 50 maybe magnetic and may allow the cover substrate 15 to magnetically seat within the cover substrate recess 54.

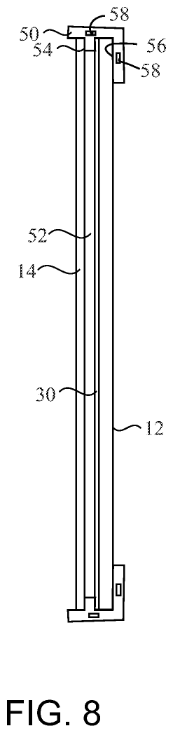

FIG. 8 illustrates a cross-sectional view of a reusable washable bulletin board including a multi-piece frame 50 constructed and arranged to enclose a removable, replaceable backing substrate 12 having a reusable, washable adhesive layer 30 disposed thereon. A cover substrate 14 may be partially disposed over the backing substrate 12 and washable adhesive layer 30, and in some variations, may define a gap 52 between the cover substrate 14 and the backing substrate 12 having a washable adhesive layer 30. The multi-piece frame 50 may include a plurality of assemblable frame portions each defining a backing substrate slot 56 and a cover substrate recess 54. According to one variation, each of the assemblable frame portions may have an approximately “F” shaped cross section. However, other variations on the cross section of each of the assemblable frame portions are contemplated by this disclosure. Each of the assemblable frame portions may define at least one keyhole 58 constructed and arranged to receive at least one key therein such that each of the assemblable frame portions may be affixed to one another at the corners of the multi-piece frame 50. In this way, the multi-piece frame 50 may securely seat the backing substrate 12 having a washable, reusable adhesive layer 30 thereon within the backing substrate slot 56 of each of the assemblable frame portions. The cover substrate 14 may be disposed within the cover substrate recess defined by each of the assemblable frame portions of the multi-piece frame 50.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a washable, reusable bulletin board may include a first frame including a first face opposite a second face and defining an outer perimeter, and an inner perimeter; a removable cover substrate at least partially framed by the first frame; a second substrate includes a reusable, washable adhesive layer; a second frame at least partially framing the second substrate; and wherein the first frame and second frame are removably attached to one another to sandwich the reusable, washable adhesive layer between the cover substrate and the second substrate.

Variation 2 may include a washable, reusable bulletin board as in variation 1 wherein the second substrate is magnetic.

Variation 3 may include a washable, reusable bulletin board as in any of variations 1 through 2 wherein the first frame is magnetic.

Variation 4 may include a washable, reusable bulletin board as in any of variations 1 through 3 wherein the second frame is magnetic.

Variation 5 may include a washable, reusable bulletin board as in any of variations 1 through 4 wherein the cover substrate is transparent.

Variation 6 may include a washable, reusable bulletin board as in any of variations 1 through 5 wherein attaching an item to the washable, reusable bulletin board does not require the use of a fastening mechanism.

Variation 7 may include a washable, reusable bulletin board as in any of variations 1 through 6 wherein the reusable, washable adhesive layer is a third substrate disposed on the second substrate.

Variation 8 may include a washable, reusable bulletin board as in any of variations 1 through 7 wherein the first frame is generally rectangular in shape.

Variation 9 may include a washable, reusable bulletin board as in any of variations 1 through 8 wherein the first frame includes a first plurality of magnets disposed therein and the cover substrate includes a second plurality of magnets disposed therein such that the cover substrate is removably attached to the first frame. According to variation 10, a washable, reusable bulletin board, may include a multi-piece frame comprising a plurality of assemblable frame portions each defining a backing substrate slot and a cover substrate recess; a removable, transparent cover substrate at least partially framed by the multi-piece frame and being at least partially disposed within the cover substrate recess; a second substrate; a third substrate comprising a reusable, washable adhesive layer, the third substrate disposed on the second substrate; and the second substrate and third substrate being removably seated within the backing substrate slot.

Variation 11 may include a washable, reusable bulletin board as in variation 10, wherein the second substrate is magnetic.

Variation 12 may include a washable, reusable bulletin board as in any of variations 10 through 11, wherein the multi-piece frame is magnetic.

Variation 13 may include a washable, reusable bulletin board as in any of variations 10 through 12, wherein the plurality of assemblable frame portions each define a plurality of key holes wherein the plurality of assemblable frame portions are removably affixed to one another via at least one key mechanically connectable with the plurality of key holes.

Variation 14 may include a washable, reusable bulletin board as in any of variations 10 through 13, wherein attaching an item to the washable, reusable bulletin board does not require the use of a fastening mechanism.

Variation 15 may include a washable, reusable bulletin board as in any of variations 10 through 14, wherein the cover substrate is at least partially disposed within the cover substrate recess.

Variation 16 may include a washable, reusable bulletin board as in any of variations 10 through 15, wherein the reusable, washable adhesive layer is a third substrate removably disposed on the second substrate.

Variation 17 may include a washable, reusable bulletin board as in any of variations 10 through 16, wherein the cover substrate is magnetic.

Variation 18 may include a washable, reusable bulletin board as in any of variations 10 through 17, wherein the multi-piece frame comprises a first plurality of magnets disposed within the cover substrate recess and the cover substrate comprises a second plurality of magnets disposed therein such that the cover substrate is removably attached to the multi-piece frame.

According to variation 19, a washable, reusable bulletin board may include an assembly of a first rectangular frame including a first face opposite a second face and defining an outer perimeter, inner perimeter, and a perimeter recess within the second face, the first frame further including a first plurality of magnets disposed within the perimeter recess; a removable cover substrate at least partially framed by the first frame, the cover substrate including a second plurality of magnets disposed therein such that the cover substrate is removably attached to perimeter recess of the first frame; a second substrate includes a reusable, washable adhesive layer; a second rectangular frame at least partially framing the second substrate and third substrate; and the first frame and second frame being removably attached to one another to sandwich the third substrate between the cover substrate and the second substrate.

Variation 20 may include a washable, reusable bulletin board as in variation 19, wherein the reusable, washable adhesive layer is a third substrate removably disposed on the second substrate.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A washable, reusable bulletin board, comprising:
a first frame comprising a first face opposite a second face and defining an outer perimeter, and an inner perimeter;
a removable cover substrate at least partially framed by the first frame;
a second, replaceable substrate comprises a reusable, washable adhesive layer;
a second frame at least partially framing the second substrate; and
the first frame and second frame being removably attached to one another to sandwich the reusable, washable adhesive layer between the cover substrate and the second, replaceable substrate.

2. A washable, reusable bulletin board as in claim 1, wherein the second substrate is magnetic.

3. A washable, reusable bulletin board as in claim 1, wherein the first frame is magnetic.

4. A washable, reusable bulletin board as in claim 1, wherein the second frame is magnetic.

5. A washable, reusable bulletin board as in claim 1, wherein the cover substrate is transparent.

6. A washable, reusable bulletin board as in claim 1, wherein attaching an item to the washable, reusable bulletin board does not require the use of a fastening mechanism.

7. A washable, reusable bulletin board as in claim 1, wherein the reusable, washable adhesive layer is a third substrate disposed on the second substrate.

8. A washable, reusable bulletin board as in claim 1, wherein the first frame is generally rectangular in shape.

9. A washable, reusable bulletin board as in claim 1, wherein the first frame comprises a first plurality of magnets disposed therein, and the cover substrate comprises a second plurality of magnets disposed therein such that the cover substrate is removably attached to the first frame.

10. A washable, reusable bulletin board, comprising:
a multi-piece frame comprising a plurality of assemblable frame portions each defining a respective backing substrate slot and a respective cover substrate recess, the assemblable frame portions being removably attached to one another to form a continuous backing substrate slot and a continuous cover substrate recess
a removable, transparent cover substrate at least partially framed by the multi-piece frame and being at least partially disposed within the continuous cover substrate recess;
a removable, replaceable second substrate;
a third substrate comprising a reusable, washable adhesive layer, the third substrate disposed on the second substrate; and
wherein the second substrate and third substrate are removably and replaceably seated within the continuous backing substrate slot and framed by the multi-piece frame.

11. A washable, reusable bulletin board as in claim 10, wherein the second substrate is magnetic.

12. A washable, reusable bulletin board as in claim 10, wherein the multi-piece frame is magnetic.

13. A washable, reusable bulletin board as in claim 10, wherein the plurality of assemblable frame portions each define a plurality of key holes wherein the plurality of assemblable frame portions are removably affixed to one another via at least one key mechanically connected to the plurality of key holes.

14. A washable, reusable bulletin board as in claim 10, wherein attaching an item to the washable, reusable bulletin board does not require the use of a fastening mechanism.

15. A washable, reusable bulletin board as in claim 10, wherein the cover substrate is at least partially disposed within the cover substrate recess.

16. A washable, reusable bulletin board as in claim 10, wherein the reusable, washable adhesive layer is a third substrate removably disposed on the second substrate.

17. A washable, reusable bulletin board as in claim 01, wherein the cover substrate is magnetic.

18. A washable, reusable bulletin board as in claim 10, wherein the multi-piece frame comprises a first plurality of magnets disposed within the cover substrate recess and the cover substrate comprises a second plurality of magnets disposed therein such that the cover substrate is removably attached to the multi-piece frame.

19. A washable, reusable bulletin board, comprising:
a first rectangular frame comprising a first face opposite a second face and defining an outer perimeter, inner perimeter, and a perimeter recess within the second face, the first frame further comprising a first plurality of magnets disposed within the perimeter recess;
a removable cover substrate at least partially framed by the first frame, the cover substrate comprising a second plurality of magnets disposed therein such that the cover substrate is removably attached to perimeter recess of the first frame;
a second substrate comprises a reusable, washable adhesive layer;
a second rectangular frame at least partially framing the second substrate and third substrate; and
the first frame and second frame being removably attached to one another to sandwich the third substrate between the cover substrate and the second substrate.

20. A washable, reusable bulletin board as in claim 19, wherein the reusable, washable
adhesive layer is a third substrate removably disposed on the second substrate.
